(19) United States
(12) Patent Application Publication
(10) Pub. No.: US 2021/0233168 A1
(43) Pub. Date: Jul. 29, 2021

(54) METHOD AND SYSTEM FOR PROCESSING ORDERS ON AN ELECTRONIC TRADING PLATFORM

(71) Applicant: JPMorgan Chase Bank, N.A., New York, NY (US)

(72) Inventors: Christopher James ADAMS, New York, NY (US); Pasquale CATALDI, London (GB); James CLENNELL, New York, NY (US); Ryan Neal ANDREWS, Glenview, IL (US)

(73) Assignee: JPMorgan Chase Bank, N.A., New York, NY (US)

(21) Appl. No.: 16/776,079

(22) Filed: Jan. 29, 2020

(51) Int. Cl. G06Q 40/04

(52) U.S. Cl. CPC G06Q 40/04; G06N 20/00

(57) ABSTRACT

A method for processing orders on an electronic trading platform is provided. The method includes receiving, via a graphical user interface, an order relating to a request to transact in a first debt instrument from a party; extracting information relating to the first debt instrument from the order; determining, using at least one curating model and the extracted information, a counterparty relating to a potential participant to the order in a counterparty database; and transmitting, via a communication network, the order to the counterparty. The method further includes receiving, via the communication network, a response relating to the order from the counterparty, the response including a transaction parameter; and displaying, via a graphical user interface, the response together with the corresponding counterparty.

### BACKGROUND

### 1. Field of the Disclosure

This technology generally relates to methods and systems for processing orders, and more particularly to methods and systems for processing transaction request orders between a party and a counterparty on an electronic trading platform for debt instruments.

### 2. Background Information

Many business entities within the financial market infrastructure industry operate client crossing engines to relate clients with buy orders to clients with sell orders. Historically, operation of such client crossing engines has resulted in varying degrees of success with respect to matching a client looking to buy a financial instrument with a client looking to sell that financial instrument.

One drawback of using conventional client crossing engines is that, in many instances, the rules used by the client crossing engines relate orders on a one-to-one basis resulting in market-inefficient pairings of prospective buyers and sellers; especially so in complex credit markets with non-standardized connectivity for communicating orders. As a result, returns for the entity operating the financial market infrastructure are reduced because of the inefficient pairings. In addition, incorrect and inefficient pairings increase overall costs for the market as a whole because of the inherent costs.

Therefore, there is a need for a communication agnostic, electronic trading platform for credit markets that process transaction orders from various interfaces accurately and efficiently.

### SUMMARY

The present disclosure, through one or more of its various aspects, embodiments, and/or specific features or sub-components, provides, inter alia, various systems, servers, devices, methods, media, programs, and platforms for processing transaction request orders between a party and a counterparty on an electronic trading platform for debt instruments.

According to an aspect of the present disclosure, a method for processing transaction request orders between a party and a counterparty on an electronic trading platform for debt instruments is provided. The method is implemented by at least one processor. The method may include receiving, via a graphical user interface, at least one order relating to a request to transact in at least one first debt instrument from at least one party; extracting information relating to the at least one first debt instrument from the at least one order; determining, by using at least one curating model and the extracted information, at least one counterparty relating to a potential participant for the at least one order in at least one counterparty database; and transmitting, via a communication network, the at least one order to the at least one counterparty.

In accordance with an exemplary embodiment, the method may further include receiving, via the communication network, at least one response relating to the at least one order from the at least one counterparty, the at least one response may include at least one transaction parameter; and displaying, via a graphical user interface, the at least one response together with the corresponding at least one counterparty.

In accordance with an exemplary embodiment, the at least one response and the corresponding at least one counterparty may be displayed in at least one list on the graphical user interface based on the at least one transaction parameter, the graphical user interface may include at least one selectable display option for arranging the list.

In accordance with an exemplary embodiment, the method may further include receiving, via the graphical user interface from the at least one party, at least one indication relating to an acceptance of at least one of the at least one response; initiating, for the at least one party, at least one first transaction relating to the at least one order according to the at least one transaction parameter corresponding to the indicated at least one response; and initiating, for the at least one counterparty, at least one second transaction relating to the at least one order according to the at least one transaction parameter corresponding to the indicated at least one response.

In accordance with an exemplary embodiment, at least one notification may be displayed on the graphical user interface when the at least one first transaction is initiated and when the at least one second transaction is initiated.

In accordance with an exemplary embodiment, the method may further include collecting market data for each of a plurality of debt instruments, the market data may include at least one of price information and trade history information; storing the market data together with each of the corresponding plurality of debt instruments in a market data repository; and updating the at least one curating model using the market data.

In accordance with an exemplary embodiment, the updating may comprise implementing at least one machine learning technique.

In accordance with an exemplary embodiment, the market data corresponding to the at least one first debt instrument may be transmitted together with the at least one order to the at least one counterparty.

In accordance with an exemplary embodiment, the at least one order may include at least one of a request for quote (RFQ) and an indication of interest (IOI).

According to another exemplary aspect of the present disclosure, a computing device configured to implement an execution of a method for processing transaction request orders between a party and a counterparty on an electronic trading platform for debt instruments is provided. The computing device comprising: a display screen; a processor; a memory; and a communication interface coupled to each of the processor, the memory, and the display screen, wherein the processor may be configured to: receive, via a graphical user interface, at least one order relating to a request to transact in at least one first debt instrument from at least one party; extract information relating to the at least one first debt instrument from the at least one order; determine, by using at least one curating model and the extracted information, at least one counterparty relating to a potential participant for the at least one order in at least one counterparty database; and transmit, via a communication network, the at least one order to the at least one counterparty.

In accordance with an exemplary embodiment, the processor may further be configured to receive, via the communication network, at least one response relating to the at least one order from the at least one counterparty, the at least one response may include at least one transaction parameter; and display, via a graphical user interface, the at least one response together with the corresponding at least one counterparty.

In accordance with an exemplary embodiment, the processor may further be configured to cause the display screen to display the at least one response and the corresponding at least one counterparty in at least one list on the graphical user interface based on the at least one transaction parameter, the graphical user interface may include at least one selectable display option for arranging the list.

In accordance with an exemplary embodiment, the processor may further be configured to receive, via the graphical user interface from the at least one party, at least one indication relating to an acceptance of at least one of the at least one response; initiate, for the at least one party, at least one first transaction relating to the at least one order according to the at least one transaction parameter corresponding to the indicated at least one response; and initiate, for the at least one counterparty, at least one second transaction relating to the at least one order according to the at least one transaction parameter corresponding to the indicated at least one response.

In accordance with an exemplary embodiment, the processor may further be configured to cause the display screen to display at least one notification on the graphical user interface when the at least one first transaction is initiated and when the at least one second transaction is initiated.

In accordance with an exemplary embodiment, the processor may further be configured to collect market data for each of a plurality of debt instruments, the market data may include at least one of price information and trade history information; store the market data together with each of the corresponding plurality of debt instruments in a market data repository; and update the at least one curating model using the market data.

In accordance with an exemplary embodiment, the processor may further be configured to implement at least one machine learning technique to update the at least one curating model.

In accordance with an exemplary embodiment, the processor may further be configured to cause the communication network to transmit the market data corresponding to the at least one first debt instrument together with the at least one order to the at least one counterparty.

In accordance with an exemplary embodiment, the at least one order includes at least one of a request for quote (RFQ) and an indication of interest (IOI).

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for processing transaction request orders between a party and a counterparty on an electronic trading platform for debt instruments.

FIG. 4 is a flowchart of an exemplary process for implementing a method for processing transaction request orders between a party and a counterparty on an electronic trading platform for debt instruments.

FIG. 5 is a flowchart of an exemplary process for implementing a method for processing transaction request orders between a party and a counterparty on an electronic trading platform for debt instruments.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer-readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

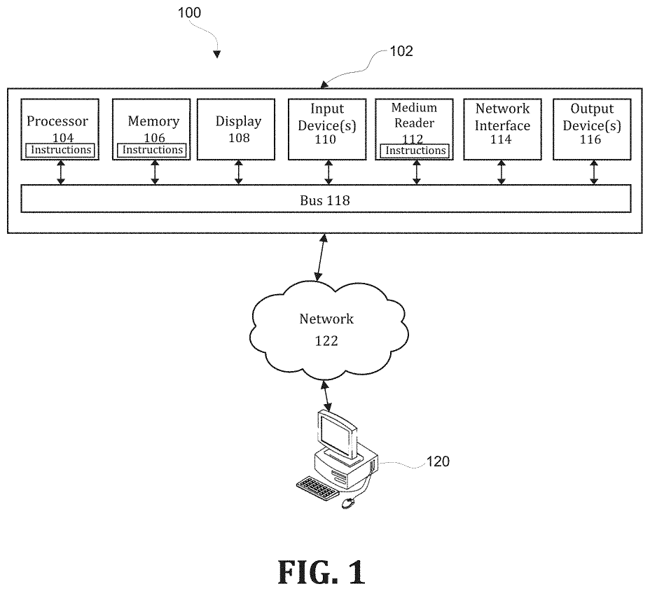

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for processing transaction request orders between a party and a counterparty on an electronic trading platform for debt instruments.

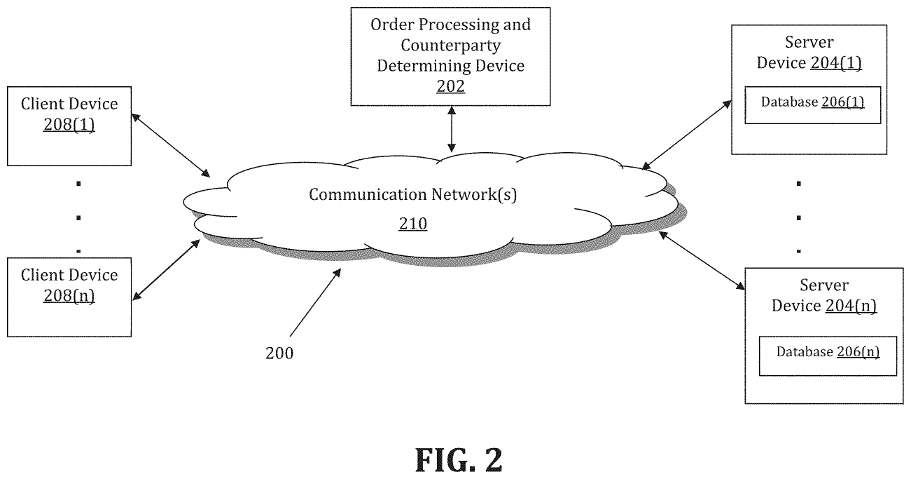

Referring to FIG. 2, a schematic of an exemplary network environment 200 for implementing a method for processing transaction request orders between a party and a counterparty on an electronic trading platform for debt instruments is illustrated. In an exemplary embodiment, the method is executable on any networked computer platform, such as, for example, a personal computer (PC).

The method for processing transaction request orders between a party and a counterparty on an electronic trading platform for debt instruments may be implemented by an Order Processing and Counterparty Determining (OPCD) device 202. The OPCD device 202 may be the same or similar to the computer system 102 as described with respect to FIG. 1. The OPCD device 202 may store one or more applications that can include executable instructions that, when executed by the OPCD device 202, cause the OPCD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OPCD device 202 itself, may be located in virtual server(s) running in a cloud-based computing environment rather than being tied to one or more specific physical network computing devices. Also, the application(s) may be running in one or more virtual machines (VMs) executing on the OPCD device 202. Additionally, in one or more embodiments of this technology, virtual machine(s) running on the OPCD device 202 may be managed or supervised by a hypervisor.

In the network environment 200 of FIG. 2, the OPCD device 202 is coupled to a plurality of server devices 204(1)-204(n) that hosts a plurality of databases 206(1)-206(n), and also to a plurality of client devices 208(1)-208(n) via communication network(s) 210. A communication interface of the OPCD device 202, such as the network interface 114 of the computer system 102 of FIG. 1, operatively couples and communicates between the OPCD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OPCD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer-readable media, and OPCD devices that efficiently implement a method for processing transaction request orders between a party and a counterparty on an electronic trading platform for debt instruments.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OPCD device 202 may be a standalone device or integrated with one or more other devices or apparatuses, such as one or more of the server devices 204(1)-204(n), for example. In one particular example, the OPCD device 202 may include or be hosted by one of the server devices 204(1)-204(n), and other arrangements are also possible. Moreover, one or more of the devices of the OPCD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OPCD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to debt instrument market data, orders information, transaction parameters, and counterparties information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OPCD device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OPCD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OPCD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OPCD device 202, the server devices 204(1)-204(n), or the client devices 208(1)-208(n), for example, may be configured to operate as virtual instances on the same physical machine. In other words, one or more of the OPCD device 202, the server devices 204(1)-204(n), or the client devices 208(1)-208(n) may operate on the same physical device rather than as separate devices communicating through communication network(s) 210. Additionally, there may be more or fewer OPCD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

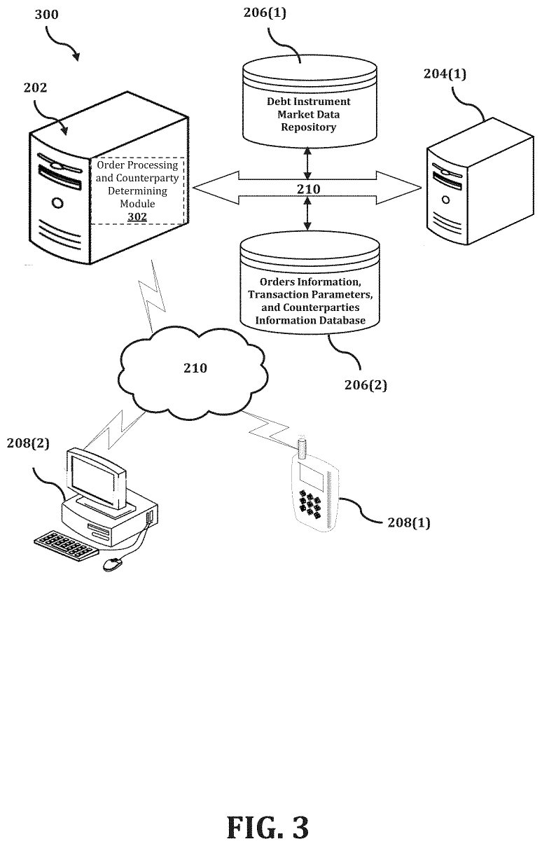

The OPCD device 202 is described and shown in FIG. 3 as including an order processing and counterparty determining module 302, although it may include other rules, policies, modules, databases, or applications, for example. As will be described below, the order processing and counterparty determining module 302 is configured to implement a method for processing transaction request orders between a party and a counterparty on an electronic trading platform for debt instruments.

An exemplary process 300 for implementing a mechanism for processing transaction request orders between a party and a counterparty on an electronic trading platform for debt instruments by utilizing the network environment of FIG. 2 is shown as being executed in FIG. 3. Specifically, a first client device 208(1) and a second client device 208(2) are illustrated as being in communication with OPCD device 202. In this regard, the first client device 208(1) and the second client device 208(2) may be “clients” of the OPCD device 202 and are described herein as such. Nevertheless, it is to be known and understood that the first client device 208(1) and/or the second client device 208(2) need not necessarily be “clients” of the OPCD device 202, or any entity described in association therewith herein. Any additional or alternative relationship may exist between either or both of the first client device 208(1) and the second client device 208(2) and the OPCD device 202, or no relationship may exist.

Further, OPCD device 202 is illustrated as being able to access a debt instrument market data repository 206(1) and an orders information, transaction parameters, and counterparties information database 206(2). The order processing and counterparty determining module 302 may be configured to access these databases for implementing a method for processing transaction request orders between a party and a counterparty on an electronic trading platform for debt instruments.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OPCD device 202 via broadband or cellular communication. Of course, these embodiments are merely exemplary and are not limiting or exhaustive.

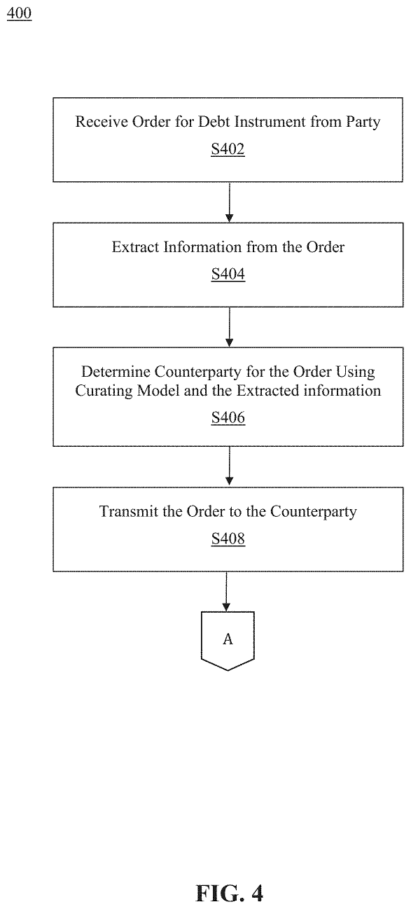

Upon being started, the order processing and counterparty determining module 302 executes a process for processing transaction request orders between a party and a counterparty on an electronic trading platform for debt instruments. An exemplary process for processing transaction request orders between a party and a counterparty on an electronic trading platform for debt instruments is generally indicated at flowchart 400 in FIG. 4.

In the process 400 of FIG. 4, at step S402, an order relating to a request to transact in a first debt instrument may be received from a party. The order may be in any format such as, for example, a request for quote (RFQ) and an indication of interest (IOI) from any application framework such as, for example, Symfony. The order may be received from any third-party user interfaces such as, for example, FlexTrade and Bloomberg as well as from any proprietary graphical user interface.

In an exemplary embodiment, the order may be a request to transact in any financial instrument. The requested transaction may include at least one of an offer to sell a financial instrument and an offer to buy a financial instrument. The financial instruments may be cash instruments whose values are directly influenced and determined by the markets such as, for example, deposits and loans, and derivative instruments whose value and characteristics are based on the financial vehicle's underlying components such as, for example, assets, interest rates, and indices. In another exemplary embodiment, the financial instruments may be an asset class of debt-based instruments such as, for example, bonds, debentures, leases, certificates, bills of exchange, and promissory notes, and an asset class of equity-based instruments such as, for example, stocks, stock options, and equity futures.

At step S404, information relating to the first debt instrument may be extracted from the order. The information relating to the first debt instrument may be, for example, the number of bonds to buy, what specific bonds to buy, and the desired maturity of a bond to buy. In an exemplary embodiment, the information may relate to the type of offer requested such as, for example, an offer to buy the bond and an offer to sell the bond. In another exemplary embodiment, the information may relate to a party such as, for example, the account number of the party initiating the order, the creditworthiness of the party initiating the order, and the current investment portfolio of the party initiating the order.

In another exemplary embodiment, the information relating to the first debt instrument may be extracted directly from unstructured order data formats as well as extracted from preprocessed, structured order data formats. For example, the information may be extracted from data formats of various electronic trading platforms with numerous, different communication standards for broad compatibility. The information may be computer-readable codes and program codes such as, for example, Hyper Text Markup Language (HTML), Extensible Markup Language (XML), and Javascript. The information may be processed and stored as optical computer-readable codes such as, for example, one-dimensional bar codes and matrix barcodes. In another exemplary embodiment, the information may be human-readable alphanumeric text.

At step S406, a counterparty relating to a potential participant for the order may be determined in a counterparty database by using a curating model and the extracted information. In an exemplary embodiment, the curating model may be a computer-based model designed to represent a relationship between the party and the counterparty. The computer-based model may curate which counterparty may be available to the party by directing a processor to select and organize the counterparties. For example, the recited system may use the curating model together with the extracted information relating to the first debt instrument to examine each of a plurality of available counterparty identifiers stored in the counterparty database to determine whether a counterparty, or several counterparties, relates to the party. In another exemplary embodiment, the counterparty identifiers may be assigned to users of the electronic trading platform and stored in the counterparty database.

In another exemplary embodiment, the curating model may include mathematical models and logic algorithms representing business guidelines for determining counterparties for an order. For example, an electronic trading platform may set a business guideline specifying that a potential buyer of A may only submit an order to a specific seller of A for a set volume of A, which results in a higher fee for the electronic trading platform. The curating model may use the extracted information from the order to determine the relationship between the party and the counterparty via any data processing modes such as, for example, transaction processing, batch processing, real time processing, and near real-time processing.

In another exemplary embodiment, the curating model may include any of various training models such as, for example, a machine learning model which may be automatically generated and further trained on additional data. Once the training model has been sufficiently trained, the training model may be deployed onto various connected systems to be utilized. In another exemplary embodiment, the training model may be sufficiently trained when model assessment methods such as, for example, the holdout method, the K-fold-cross-validation method, and the bootstrap method determine that the model's true positive rate, true negative rate, false positive rate, and false negative rates correspond to predetermined ranges. In another exemplary embodiment, the training model may be operable (i.e., actively utilized by an organization) while continuing to be trained using new data. In another exemplary embodiment, the curating model may be automatically generated using at least one of an artificial neural network technique, a decision tree technique, a support vector machines technique, a Bayesian network technique, and a genetic algorithms technique.

At step S408, the order may be transmitted via a communication network to the counterparty. In an exemplary embodiment, the order may be transmitted to the counterparty together with data relating to the order such as, for example, market data corresponding to the first debt instrument. As will be appreciated by a person of ordinary skill in the art, the communication network may refer to a collection of terminal nodes connected by transmission links to enable communication between computing terminals.

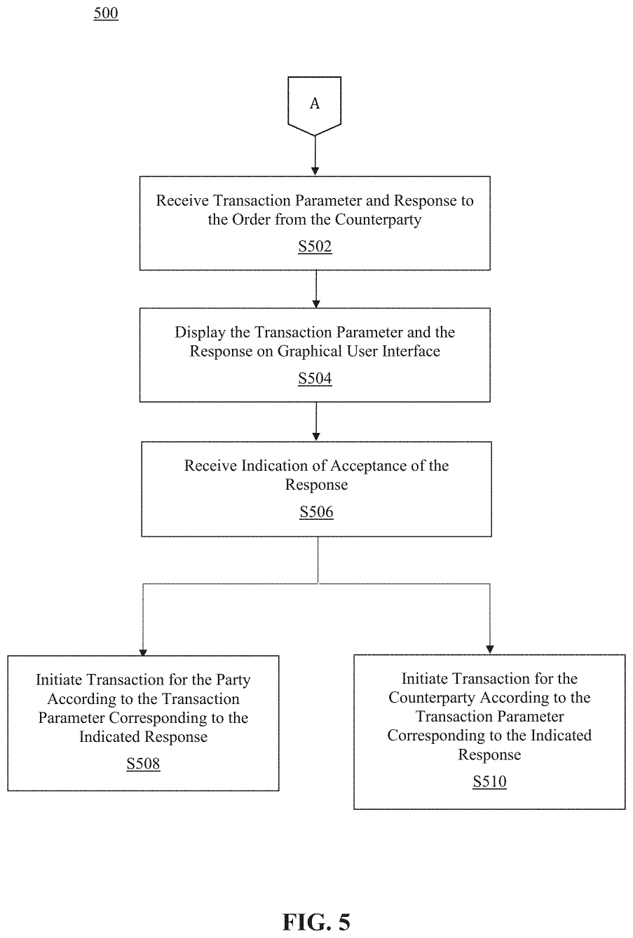

Then, in the process 500 of FIG. 5, at step S502, a response relating to the order may be received from the counterparty. The response may be in any format such as, for example, a reply sheet for a request for quote (RFQ) from any application framework such as, for example, Symfony. The response may be received from any third-party user interfaces such as, for example, FlexTrade and Bloomberg as well as from any proprietary graphical user interface. In an exemplary embodiment, the response from the counterparty may be a binding offer such as, for example, an offer to sell A at price B in response to the order to buy A, which becomes binding on the counterparty when accepted by the party. In another exemplary embodiment, the response from the counterparty may be a non-binding offer such as, for example, an offer to sell A at price range B to C, depending on volume of A, in response to the order to buy A, which requires additional approval by the counterparty, the party, or a third-party before the offer may become binding.

In another exemplary embodiment, the response from the counterparty may include a transaction parameter. The transaction parameter may include terms relating to the order such as, for example, a proposed price from the counterparty in response to the order made by the party. In another exemplary embodiment, the transaction parameter may include information relating to the disposition of the order such as, for example, an account number of the counterparty, which may be used to initiate a transaction for the counterparty.

At step S504, the response together with information relating to the corresponding counterparty may be displayed on a graphical user interface for the party. In another exemplary embodiment, the response and information relating to the corresponding counterparty may be displayed in a list on the graphical user interface based on the transaction parameter. The graphical user interface may include a selectable display option for arranging the list. The list may be an ascending or descending display of the response and information relating to the corresponding counterparty. In another exemplary embodiment, the list may be a digital space such as, for example, a virtual room, accessible from the graphical user interface by the party, containing a plurality of counterparties with similar characteristics.

In another exemplary embodiment, the response and information relating to the corresponding counterparty may be displayed on a graphical user interface according to any predetermined transaction parameter. For example, the response and information relating to the corresponding counterparty may be displayed based on a time when the response was received. In another exemplary embodiment, the graphical user interface may include selectable elements for selecting the desired transaction parameter to display the response and information relating to the corresponding counterparty.

At step S506, at least one indication relating to an acceptance of the response by the party may be received via the graphical user interface. The indication may be any input received through a physical input device such as, for example, a keyboard and mouse as well as a virtual input device such as, for example, a selectable element on the graphical user interface of a display. In an exemplary embodiment, the party may be presented with multiple selection options. Selection of an option may indicate an affirmative acceptance by the party to select a specific response as well as the corresponding transaction parameter.

At step S508, a first transaction relating to the order may be initiated for the party according to the transaction parameter corresponding to the indicated response. Then, at step S510, a second transaction relating to the order may be initiated for the counterparty according to the transaction parameter corresponding to the indicated response. In an exemplary embodiment, the first transaction may be dependent upon the second transaction such that, for example, both transactions may be initiated at the same time when an indication is received that the response has been accepted by the party. In another exemplary embodiment, the first transaction and the second transaction may be initiated independently. For example, the first transaction and the second transaction may be completed at different times based on any business standard.

In another exemplary embodiment, the first transaction and the second transaction may include transactions which are made directly between the party and the counterparty as well as transactions which are made between the party and the electronic trading platform, and the counterparty and the electronic trading platform. When the first transaction and the second transaction may be made directly between the party and the counterparty, the electronic trading platform may perform the functions of a broker such as, for example, an investment broker helping to find buyers and sellers of investment securities. When the first transaction may be made between the party and the electronic trading platform and the second transaction may be made between the counterparty and the electronic trading platform, the electronic trading platform may perform the functions of a clearing house such as, for example, taking the opposite position of each side of a trade to reduce the cost and risk of settling transactions between the party and the counterparty.

In another exemplary embodiment, market data for each of a plurality of debt instruments available for trading on the electronic trading platform may be collected from publicly available sources such as, for example, a public exchange as well as from private sources such as, for example, a financial institution. The market data may include any information relating to each of the plurality of debt instruments such as, for example, price information and trade history information. In another exemplary embodiment, the market data corresponding to the first debt instrument may be displayed together with the response from the counterparty on the graphical user interface. In another exemplary embodiment, the market data may be stored together with each of the corresponding debt instruments in a market data repository. As will be appreciated by a person of ordinary skill in the art, the market data repository may utilize any appropriate file system to control how data may be stored and may be retrieved.

In another exemplary embodiment, the curating model may be updated using the market data. Updating the curating model with the market data may occur in a single instance, several predetermined instances, as well as continuously while the curating model is in use. In another exemplary embodiment, updating the curating model may comprise implementing machine learning techniques such as, for example, supervised learning techniques, unsupervised learning techniques, and reinforcement learning techniques to train the curating model.

In another exemplary embodiment, a notification may be displayed on the graphical user interface when the first transaction is initiated and when the second transaction is initiated. The notification may be a visual notification such as, for example, a textual notification on the graphical user interface, an audible notification such as, for example, a sound played via speakers connected to a user device, and a tactile notification such as, for example, a vibration via a vibrating element of a user device. In an exemplary embodiment, the notification may be a textual notification on the graphical user interface that may include information relating to the initiation of the first transaction and the initiation of the second transaction. For example, the textual notification may include information explaining that the first transaction has been initiated and instructions for how the party may proceed with the order. In an exemplary embodiment, the textual notification may include selectable elements relating to the disposition of the notification as well as selectable elements relating to the disposition of the order.

In another exemplary embodiment, the curating model may be used to assign a score to the response based on the transaction parameter and predetermined criteria. The predetermined criteria may be business related criteria such as, for example, a transaction fee structure of the electronic trading platform or market related criteria such as, for example, a pricing structure yielding the most profitable returns for the party. For example, the electronic trading platform may highlight a specific response when multiple responses have similar prices using a predetermined criterion that maximizes the collection of fees.

In another exemplary embodiment, the assigned score may be human-readable alphanumeric text and computer-readable code. The assigned score may be linked to the response for a particular order. For example, the response and the corresponding assigned score may be temporarily stored and linked to only the particular order. In another exemplary embodiment, the assigned score may be a representation of how closely the response satisfies the predetermined criteria. For example, the response may be assigned a high score when the response satisfies all the predetermined criteria and assigned a low score when the response satisfies only one of the predetermined criteria.

Accordingly, with this technology, an optimized process for processing transaction request orders between a party and a counterparty on an electronic trading platform for debt instruments is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for processing orders on an electronic trading platform, the method being implemented by at least one processor, the method comprising:
receiving, by the at least one processor via a graphical user interface, at least one order relating to a request to transact in at least one first debt instrument from at least one party;
extracting, by the at least one processor, information relating to the at least one first debt instrument from the at least one order;
determining, by the at least one processor using at least one curating model and the extracted information, at least one counterparty relating to a potential participant for the at least one order in at least one counterparty database; and
transmitting, by the at least one processor via a communication network, the at least one order to the at least one counterparty.

2. The method of claim 1, further comprising:
receiving, by the at least one processor via the communication network, at least one response relating to the at least one order from the at least one counterparty, the at least one response including at least one transaction parameter; and
displaying, by the at least one processor via a graphical user interface, the at least one response together with the corresponding at least one counterparty.

3. The method of claim 2, wherein the at least one response and the corresponding at least one counterparty is displayed in at least one list on the graphical user interface based on the at least one transaction parameter, the graphical user interface including at least one selectable display option for arranging the list.

4. The method of claim 2, further comprising:
receiving, by the at least one processor via the graphical user interface from the at least one party, at least one indication relating to an acceptance of at least one of the at least one response;
initiating, by the at least one processor for the at least one party, at least one first transaction relating to the at least one order according to the at least one transaction parameter corresponding to the indicated at least one response; and
initiating, by the at least one processor for the at least one counterparty, at least one second transaction relating to the at least one order according to the at least one transaction parameter corresponding to the indicated at least one response.

5. The method of claim 4, wherein at least one notification is displayed on the graphical user interface when the at least one first transaction is initiated and when the at least one second transaction is initiated.

6. The method of claim 1, the method further comprising:
collecting, by the at least one processor, market data for each of a plurality of debt instruments, the market data including at least one of price information and trade history information;
storing, by the at least one processor, the market data together with each of the corresponding plurality of debt instruments in a market data repository; and
updating, by the at least one processor, the at least one curating model using the market data.

7. The method of claim 6, wherein the updating comprises implementing at least one machine learning technique.

8. The method of claim 6, wherein the market data corresponding to the at least one first debt instrument is transmitted together with the at least one order to the at least one counterparty.

9. The method of claim 1, wherein the at least one order includes at least one of a request for quote (RFQ) and an indication of interest (IOI).

10. A computing device configured to implement an execution of a method for processing orders on an electronic trading platform, the computing device comprising:
a display screen;
a processor;
a memory; and
a communication interface coupled to each of the processor, the memory, and the display screen,
wherein the processor is configured to:
receive, via a graphical user interface, at least one order relating to a request to transact in at least one first debt instrument from at least one party;
extract information relating to the at least one first debt instrument from the at least one order;
determine, by using at least one curating model and the extracted information, at least one counterparty relating to a potential participant for the at least one order in at least one counterparty database; and
transmit, via a communication network, the at least one order to the at least one counterparty.

11. The computing device of claim 10, wherein the processor is further configured to:
receive, via the communication network, at least one response relating to the at least one order from the at least one counterparty, the at least one response including at least one transaction parameter; and
display, via a graphical user interface, the at least one response together with the corresponding at least one counterparty.

12. The computing device of claim 11, wherein the processor is further configured to cause the display screen to display the at least one response and the corresponding at least one counterparty in at least one list on the graphical user interface based on the at least one transaction parameter, the graphical user interface including at least one selectable display option for arranging the list.

13. The computing device of claim 11, wherein the processor is further configured to:
receive, via the graphical user interface from the at least one party, at least one indication relating to an acceptance of at least one of the at least one response;
initiate, for the at least one party, at least one first transaction relating to the at least one order according to the at least one transaction parameter corresponding to the indicated at least one response; and
initiate, for the at least one counterparty, at least one second transaction relating to the at least one order according to the at least one transaction parameter corresponding to the indicated at least one response.

14. The computing device of claim 13, wherein the processor is further configured to cause the display screen to display at least one notification on the graphical user interface when the at least one first transaction is initiated and when the at least one second transaction is initiated.

15. The computing device of claim 10, wherein the processor is further configured to:
collect market data for each of a plurality of debt instruments, the market data including at least one of price information and trade history information;
store the market data together with each of the corresponding plurality of debt instruments in a market data repository; and
update the at least one curating model using the market data.

16. The computing device of claim 15, wherein the processor is further configured to implement at least one machine learning technique to update the at least one curating model.

17. The computing device of claim 15, wherein the processor is further configured to cause the communication network to transmit the market data corresponding to the at least one first debt instrument together with the at least one order to the at least one counterparty.

18. The computing device of claim 10, wherein the at least one order includes at least one of a request for quote (RFQ) and an indication of interest (IOI).
